(19) United States
(12) Patent Application Publication
(10) Pub. No.: US 2012/0010929 A1
(43) Pub. Date: Jan. 12, 2012

(54) METHOD AND SYSTEM FOR MARKETING

(76) Inventors: Vijay Kolli, Schaumburg, IL (US); Greg Black, Vernon Hills, IL (US); William Hede, Lake in the Hills, IL (US)

(21) Appl. No.: 12/831,899

(22) Filed: Jul. 7, 2010

(51) Int. Cl. G06Q 30/00

(52) U.S. Cl. 705/14.16; 705/14.72; 705/14.49

(57) ABSTRACT

A method for marketing and system for marketing are disclosed. In one embodiment, a method for marketing a product includes identifying the product at a mobile device associated with a user, and generating a message indicative of an endorsement of the product by the user, the generating being performed at least in part by way of the mobile device. The method further includes causing, by way of the mobile device, a sending of the message to at least one receiving device associated with at least one personal social contact of the user. Due to the causing, a seller of the product is also notified that the sending of the message has occurred.

### CROSS-REFERENCE TO RELATED APPLICATIONS

N/A

### STATEMENT REGARDING FEDERALLY SPONSORED RESEARCH OR DEVELOPMENT

N/A

### FIELD OF THE INVENTION

The present invention relates generally to methods and systems for marketing, and in at least some embodiments particularly relates to methods and systems for marketing products through the use of mobile devices.

### BACKGROUND OF THE INVENTION

Numerous different methodologies have been developed for marketing or promoting the sale of products and services (collectively referred to in general hereinafter simply as “products”). Many conventional marketing methodologies are initiated and exclusively controlled by the manufacturers or retailers of products. Yet such marketing methodologies may lack effectiveness, or at least may lack desired levels of effectiveness, to the extent that the methodologies are not sufficiently tailored to reflect or respond to changing consumer desires. Indeed, often it is difficult to take into account consumer desires when developing and implementing the marketing methodologies, either because such information is entirely unavailable or because useful information is difficult to obtain in a timely fashion.

Therefore, for at least the above reasons, it would be advantageous if a new marketing method and/or system could be developed that, when used in place of or in addition to existing marketing methods and systems, produced better results. More particularly, it would be advantageous if such a new marketing method and/or system could be developed that to at least some extent more effectively took into account consumer desires and thereby achieved (or helped to achieve) enhanced results.

### BRIEF SUMMARY OF THE INVENTION

In at least some embodiments, the present invention relates to a method for marketing a product. The method includes identifying the product at a mobile device associated with a user, and generating a message indicative of an endorsement of the product by the user, the generating being performed at least in part by way of the mobile device. The method further includes causing, by way of the mobile device, a sending of the message to at least one receiving device associated with at least one personal social contact of the user. Due to the causing, a seller of the product is also notified that the sending of the message has occurred.

In at least some additional embodiments, the present invention relates to a method of marketing a product. The method includes receiving at a first server, from a mobile device associated with a user, an indication of a product that has been identified. The method also includes communicating with the mobile device regarding a message indicative of an endorsement of the product by the user, verifying that the message satisfies at least one criterion established by a seller of the product, and causing the message to be sent to at least one receiving device associated with at least one personal contact of the user.

In at least some further embodiments, the present invention relates to a system for marketing. The system includes a mobile device having a plurality of components including a processing device, a memory device, one or more input devices, and a wireless transceiver, wherein each of the memory device, the one or more input devices, and the wireless transceiver are connected at least indirectly with the processing device by way of one or more internal communication links. The one or more input devices includes one or more of a user interface by which a user can identify a product, a scanner by which a bar code associated with the product can be detected by the mobile device, and an image detector by which an image of the product can be detected. The mobile device is capable of being operated by a user so as to generate a message endorsing the product, and the mobile device is capable of communicating via the wireless transceiver with a first server with respect to the message and, as a result of the communicating, the message is transmitted to one or more receiving devices associated with one or more personal contacts of the user

### BRIEF DESCRIPTION OF THE DRAWINGS

FIG. 1 is a block diagram showing a communication system that is able to perform an enhanced marketing method in accordance with one embodiment of the present invention;

FIG. 2 is a block diagram illustrating exemplary components of the mobile device of the communication system of FIG. 1;

FIG. 3 is a flow chart showing exemplary steps of an enhanced marketing method that can be implemented using the communication system of FIG. 1; and

FIG. 4 is an additional flow chart showing exemplary steps of an additional enhanced marketing method that can be implemented using the communication system of FIG. 1.

### DETAILED DESCRIPTION OF THE INVENTION

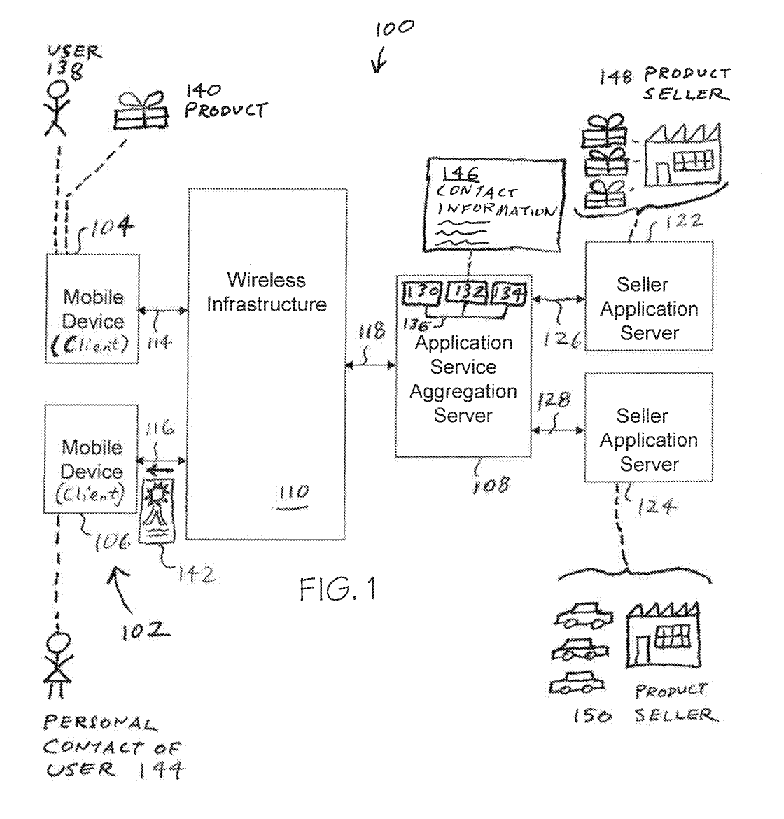

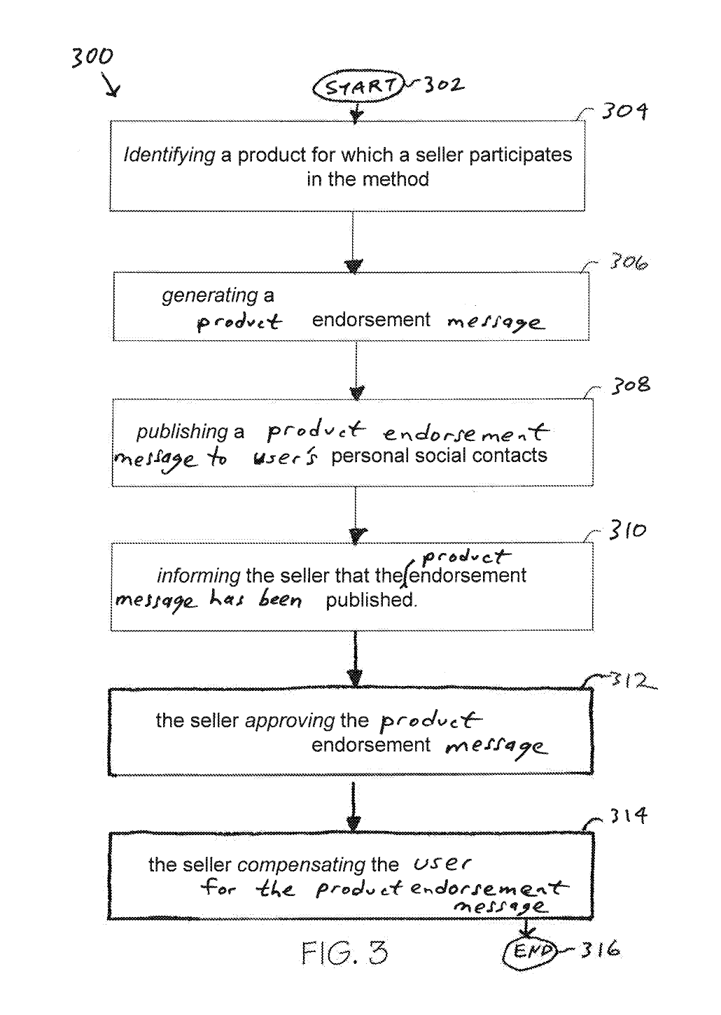

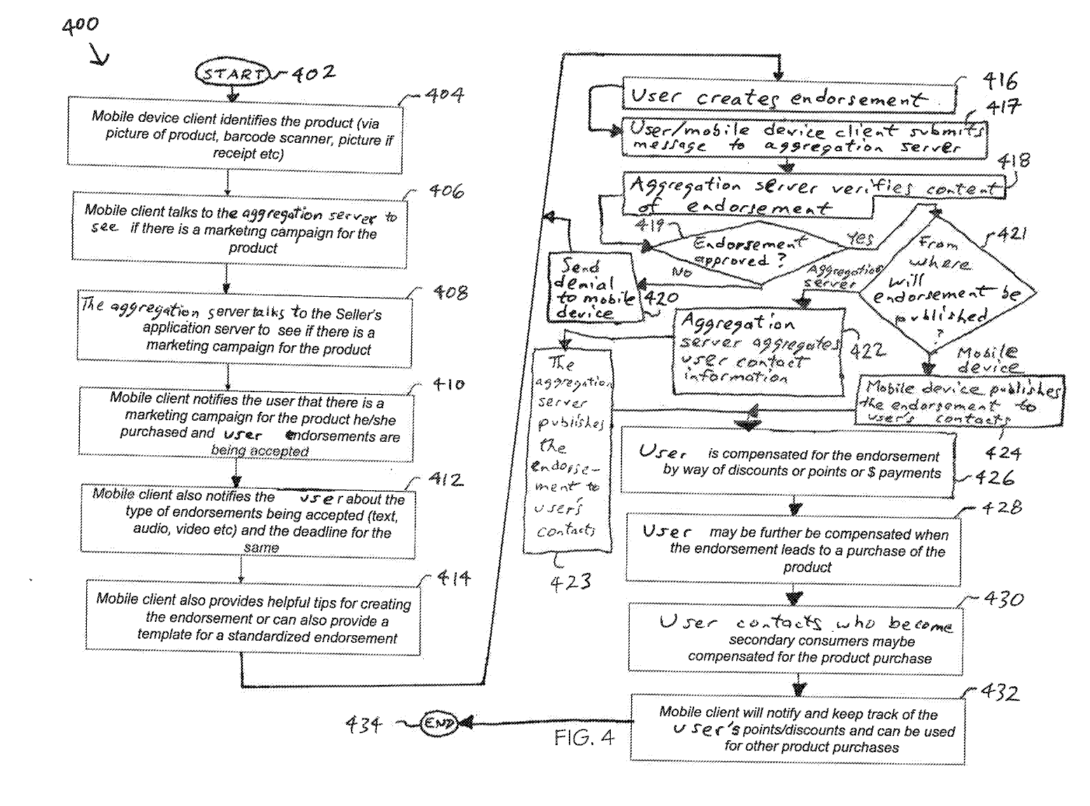

Referring to FIG. 1, a schematic view is provided of a communication system 100 that can be utilized to perform one or more marketing methods in accordance with one or more embodiments of the present invention such as, for example, marketing methods discussed in further detail below with respect to FIGS. 3 and 4. In the present embodiment, the communication system 100 includes a plurality of mobile devices 102 that include a first mobile device 104 and a second mobile device 106. The mobile devices 104, 106 can take a variety of forms depending upon the embodiment. In the present example shown, each of the mobile devices 104, 106 is a personal digital assistant (PDA), albeit the mobile devices are also intended to be representative of a variety of other mobile/portable devices that are encompassed within the scope of the present invention including, for example, cellular telephones, smart phones, other handheld or portable electronic devices, headsets, MP3 players, battery-powered devices, wearable devices, radios, navigation devices, pagers, scanning devices, and other mobile devices.

Further as shown, each of the plurality of mobile devices 102 and particularly each of the mobile devices 104, 106 is in communication with, or at least capable of communications with, an application service aggregation server (hereinafter simply referred to as the “aggregation server”) 108. The communications between the plurality of mobile devices 102 and the aggregation server 108 are, in the present embodiment, achieved by way of wireless communications facilitated by wireless infrastructure 110 interposed between the aggregation server and the mobile devices. More particularly, as shown, the first and second mobile devices 104 and 106 is in communication with the wireless infrastructure 110 by way of first and second communication links 114 and 116, which are cellular communication links, and the wireless infrastructure 110 is additionally in communication with the aggregation server 108 by way of a third communication link 118, which is an internet communication link. The component(s) forming the wireless infrastructure 110 can vary depending upon the embodiment and, among other things, can include one or more of a cellular tower and a WiFi transceiver. Also, the manner of communications between the mobile (or wireless) devices 104, 106 and the aggregation server 108 can vary in other manners from that shown depending upon the embodiment. For example, in another alternate embodiment, the mobile devices 104, 106 can communicate directly with the aggregation server 108 via internet communication links (not shown), for example via local area networks (LANs) or wireless local area networks (WLANs).

In addition to being in communication with the mobile devices 104, 106 via the wireless infrastructure 110, the aggregation server 108 is also in communication with (or capable of communications with) a plurality of seller application servers 120, which in the present embodiment includes a first seller application server 122 and a second seller application server 124. More particularly as shown, the first seller application server 122 is in communication with the aggregation server 108 by way of a fourth communication link 126, which is an internet communication link, while the second seller application server 124 is in communication with the aggregation server 108 by way of a fifth communication link 128, which also is an internet communication link. While the mobile devices 104, 106 are clients of the aggregation server 108, the seller application servers are servers in their own right, and the aggregation server 108 can operate as a client in relation to the seller application servers 122, 124.

As will be described in further detail with respect to FIGS. 3-4, in the present exemplary embodiment, the first mobile device 104 is associated with (e.g., owned and/or operated by) a user 138 and is operated in a manner by which a product 140 is identified at the first mobile device. The term “user” is employed to indicate that the user 138 owns/operates the mobile device 104, rather than being employed to signify the particular relationship of that person with the product 140. That is, although the user 138 can also be a user of the product 140, the user 138 need not in fact be using the product. Nor is it necessarily the case that the user own or possess the product (albeit in many cases it is possible that the user will own the product or will have just recently purchased the product). Rather, the user 138 can simply be a person who is interested in the product such as a customer for/purchaser of the product, or a person who has some familiarity with the product. Thus, the product 140 can be a product that is owned or in possession of the user 138 or, alternatively, simply a product that is identified in some other manner to and/or by the first mobile device 104.

Upon a product such as the product 140 being identified, in accordance with embodiments of the present invention, one or more product endorsement messages 142 are created that are in turn sent to mobile devices or other receiving devices associated with personal contacts (e.g., friends or family) of the user 138, for example, the mobile device 106 which is shown in FIG. 1 to be associated with a user personal contact 144. The product endorsement messages 142 are directed to the receiving devices based upon contact information 146 available to the communication system 100 (in the present exemplary embodiment, the contact information can be stored in the memory device(s) 132 of the aggregation server 108). As for the seller application servers 120, these servers are owned and/or operated by (or otherwise operated under the direction or control of) manufacturers, retailers or other parties that are offering various products in the market. For example, in the embodiment of FIG. 1, the first seller application server 122 is operated by a product seller 148 that manufactures products such as the product 140, while the second seller application server 124 is operated by a product seller 150 that provides a different type of product. As already mentioned above, the term “products” as used herein is intended to broadly encompass both products as well as services.

It should be understood that FIG. 1 is intended to be representative of a variety of embodiments of the present invention. Among other things, while FIG. 1 shows particularly the two mobile devices 104, 106, the present invention is intended to encompass embodiments having any arbitrary number of mobile devices (although, as will be discussed further below, typically at least two mobile devices will be present). Indeed, typically many more than two (e.g., dozens, or hundreds of) mobile devices of various users will be in communication with the aggregation server 108. Additionally, while FIG. 1 shows the two seller application servers 122, 124, the present invention is intended to encompass embodiments having any arbitrary number of seller application servers, including embodiments where there is only a single seller application server (or even no seller application server) involved. Further, although both of the mobile devices 104, 106 of FIG. 1 are shown to be in communication with the aggregation server 108 by way of the same wireless infrastructure 110, the wireless infrastructure shown in FIG. 1 should be understood to include, among other things, multiple wireless communications components or devices that respectively facilitate communications between respective ones of the mobile devices 102 and the aggregation server 108. That is, in some embodiments, different ones of the plurality of mobile devices 102 can be in communication with the aggregation server 108 by way of distinct wireless infrastructure components or devices, or by direct internet communications.

It should further be understood that, although not necessarily the case in all embodiments, in at least some embodiments communications conducted between the mobile devices 104, 106 and the aggregation server 108, as well as between the seller application servers 122, 124 and the aggregation server 108, are internet-type communications conducted via the World Wide Web (WWW). Further, the communication links 114, 116, 118, 126, and 128 (and especially the links 118, 126, and 128) as well as the wireless infrastructure 110 can be considered portions of the internet in such embodiments. Therefore, insofar as the mobile devices 104, 106 in the present embodiment are clients of the aggregation server 108, in such internet-type embodiments the mobile devices 104, 106 are web clients and the aggregation server 108 is a web server, and the mobile devices 104, 106 can access the web server through the use of web browser programs operating on those mobile devices. Also, insofar as the aggregation server 108 operates as a client relative to the seller application servers 122, 124, in such internet-type embodiments the aggregation server 108 is a web client vis-à-vis the seller application servers 122, 124, with the seller application servers in turn serving as web servers. Via the internet and/or other networks, embodiments of the present invention can potentially allow for product endorsement messages to be sent from, or sent to, any mobile or other devices that are connected/in communication via any of these networks. For example, in some alternate embodiments, in addition to or instead of the mobile devices, other connected devices such as a computer, connected multimedia device (e.g., the iPod Touch available from Apple Inc. of Cupertino, Calif.), or internet-connected television can also be in communication with the aggregation server.

Still referring to FIG. 1, it will be understood that the aggregation server 108 can be of conventional design and, among other things, can include one or more processing devices (e.g., a microprocessor) 130, one or more memory devices 132, and one or more input/output devices 134 that allow the aggregation server 108 to communicate with the mobile devices 104, 106 and seller application servers 122, 124 by way of the communication links 114, 116, 118, 126, 128 (and the wireless infrastructure 110). The processing device(s) 130, memory device(s) 132, and input/output device(s) can all be in communication with one another by way of one or more internal communication link(s) such as an internal communication bus 136. The aggregation server 108 will store within its memory device(s) 132 operating system(s), application(s), and informational data allowing for operation of the aggregation server as well as allowing for the aggregation server to interact with the mobile devices 104, 106 and the seller application servers 122, 124 as discussed in further below to perform the marketing method(s) described in further detail below with respect to FIGS. 3-4. Among the application(s) of the aggregation server 108 can be included a web browser program allowing for the aggregation server to interact with the seller application servers 122, 124.

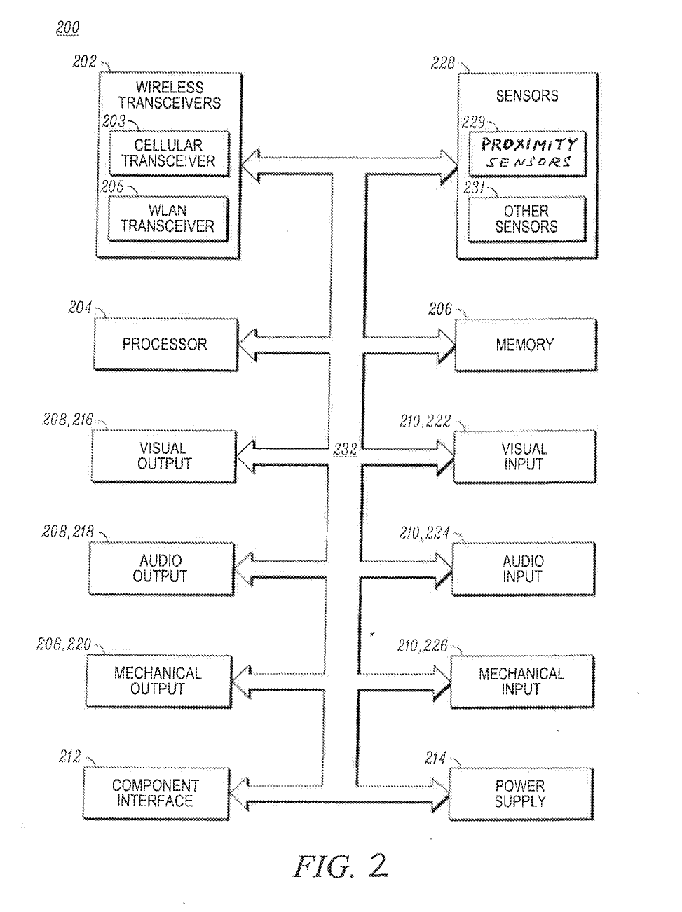

Referring to FIG. 2, there is provided a block diagram illustrating exemplary internal components 200 of a mobile device such as each of the mobile devices 104, 106, in accordance with the present invention. The exemplary embodiment includes wireless transceivers 202, a processor 204 (e.g., a microprocessor, microcomputer, application-specific integrated circuit, etc.), a memory portion 206, one or more output devices 208, and one or more input devices 210. In at least some embodiments, a user interface is present that comprises one or more output devices 208 and one or more input device 210. The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile devices 104, 106 to be portable. The internal components 200 in the present embodiment further include any of a variety of sensors 228. All of the internal components 200 can be coupled to one another, and in communication with one another, by way of one or more internal communication links 232 (e.g., an internal bus).

Each of the wireless transceivers 202 utilizes a wireless technology for communication, such as, but not limited to, cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF, Bluetooth and IEEE 802.11(a, b, g or n), or other wireless communication technologies such as infrared technology. In the present embodiment, the wireless transceivers 202 include both cellular transceivers 203 and a wireless local area network (WLAN) transceiver 205 (which particularly can employ infrared technology), although in other embodiments only one of these types of wireless transceivers (and possibly neither of these types of wireless transceivers, and/or other types of wireless transceivers) is present. Also, the number of wireless transceivers can vary and, in some embodiments, only one wireless transceiver is present and further, depending upon the embodiment, each wireless transceiver 202 can include both a receiver and a transmitter, or only one or the other of those devices. It will be understood that it is particularly the cellular transceiver 203 of each of the mobile devices 104, 106 that allows for the respective mobile device to communicate with the wireless infrastructure 110 as shown in FIG. 1.

Exemplary operation of the wireless transceivers 202 in conjunction with others of the internal components 200 of the mobile devices 104, 106 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals to a remote device, such as a cell tower, WLAN access point, or a remote server (not shown).

Depending upon the embodiment, the input and output devices 208, 210 of the internal components 200 can include a variety of visual, audio and/or mechanical outputs. For example, the output device(s) 208 can include a visual output device 216 such as a liquid crystal display and light emitting diode indicator, an audio output device 218 such as a speaker, alarm and/or buzzer, and/or a mechanical output device 220 such as a vibrating mechanism. The visual output devices 216 among other things can include the video screen 6 of FIG. 1. Likewise, by example, the input devices 210 can include a visual input device 222 such as an optical sensor (for example, a camera or scanner), an audio input device 224 such as a microphone, and a mechanical input device 226 such as a flip sensor, keyboard, keypad, selection button, touch pad, touchscreen, capacitive sensor, motion sensor, and switch. The mechanical input device 226 can in particular include, among other things, the keypad 8 and the navigation device 10 of FIG. 1. Actions that can actuate one or more input devices 210 can include, but need not be limited to, opening the mobile device, unlocking the device, moving the device to actuate a motion, moving the device to actuate a location positioning system, and operating the device.

As for the sensors 228, these can include both proximity sensors 229 and other sensors 231. The proximity sensors 229 can include, for example, infrared sensing devices and/or other types of proximity detectors such as electromagnetic proximity detectors. By comparison, the other sensors 231 can include other types of sensors, such as a location circuit 228 that can include, for example, a Global Positioning System (GPS) receiver, a triangulation receiver, an accelerometer, a gyroscope, or any other information collecting device that can identify a current location of the mobile device on which it is implemented. The sensors 228 can in at least some circumstances be considered as being encompassed within input devices 210 (or the two groupings can be considered to overlap entirely or to some degree).

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. The data that is stored by the memory portion 206 can include, but need not be limited to, operating systems, applications, and informational data. Each operating system includes executable code that controls basic functions of the communication device, such as interaction among the various components included among the internal components 200, communication with external devices via the wireless transceivers 202 and/or the component interface 212, and storage and retrieval of applications and data to and from the memory portion 206. Each application includes executable code that utilizes an operating system to provide more specific functionality for the communication devices, such as file system service and handling of protected and unprotected data stored in the memory portion 206. Informational data is non-executable code or information that can be referenced and/or manipulated by an operating system or application for performing functions of the communication device.

Referring to FIGS. 3 and 4, first and second flowcharts 300 and 400, respectively, are provided to show exemplary steps of two versions of marketing methods that can be implemented by way of the communication system 100 of FIG. 1 and are intended to be encompassed by the present invention. With respect to FIG. 3 in particular, the process represented by the flowchart 300 can be understood to be a simplified (high-level) version of one of the marketing methods encompassed by the present invention. In this embodiment, the marketing method can be understood to include six steps 304-314 after beginning at a start step 302 and prior to concluding at an end step 316. As shown, upon starting at the step 302, the process begins at a step 304 by identifying a product associated with a user, such as the product 140 at the mobile device 104 of the user 138 of FIG. 1. The product 140 can be identified in a variety of manners depending upon the embodiment or circumstance, some of which are described in further detail with respect to FIG. 4. Upon the product being identified, the identified product information, along with information regarding the mobile device 104 and the user 138 associated therewith, is communicated from the mobile device 104 to the aggregation server 108. This information is transmitted by way of appropriate ones of the communication links 114, 118, as well as by way of the wireless infrastructure 110 and possibly by way of internet-type communications.

Next, at a step 306, the aggregation server 108 generates one or more product endorsement messages, such as the product endorsement message 142 of FIG. 1, that are reflective of the identified product 140. The product endorsement message(s) 142 indicate that the user 138 associated with the mobile device 104 at which the product 140 was identified endorses the product or, at least, endorses one or more features or aspects of the product. Notwithstanding the above description, although in some embodiments the generating of the product endorsement message(s) performed at the step 306 is performed entirely (e.g., automatically) by way of the aggregation server 108 upon receiving product identification information from the mobile device 104, in other embodiments (and as discussed for example with respect to FIG. 4) the product endorsement message(s) are instead generated by the mobile device 104 itself, or by the mobile device 104 in collaboration with the aggregation server 108. In some circumstances, the mobile device 104 can provide visual/image information (entered via the visual input device 222) and/or audio information (entered via the audio input device 224) that is used in generating the product endorsement 142, such that the product endorsement advantageously include images and sounds from (for example) the user 138 and the product 140.

Next, at a step 308, the process further involves sending out or publishing of the product endorsement message(s) to personal social contacts of the user of the mobile device 104 at which the product was identified, for example, the user personal contact 144 of FIG. 1. In some embodiments, the publishing can be performed entirely by the aggregation server 108, which will have stored thereon (e.g., in the memory devices 132) contact information such as the contact information 146 regarding the personal social contacts of the user of the mobile device 104. The contact information can take any of a variety of forms including, for example, email addresses, phone numbers, and other types of contact information. Such contact information can be obtained by the aggregation server 108 from the mobile device 104 associated with the user 138, either on an ongoing basis as the mobile device 104 interacts with the aggregation server over time, or at the time at which the identified product information is sent to the aggregation server in accordance with the step 304. The aggregation server 108 publishes the product endorsement message(s) 142 by sending appropriate ones of the message(s) to receiving devices such as other mobile devices including, for example, the second mobile device 106. The product endorsement message(s) are sent by way of appropriate ones of the communication links such as the links 116, 118 and the wireless infrastructure 110 and, in at least some embodiments or circumstances, the messages are sent by way of internet-type communications.

Although FIG. 1 illustrates an example in which the second mobile device 106 can be the recipient of the published product endorsement message 142, it should be understood that any number (and typically more than one, e.g., dozens) of devices will receive such product endorsement messages. Although often the receiving devices will be mobile devices such as the mobile device 106, such receiving devices need not necessarily be mobile devices but rather can also include other types of devices such as fixed computer terminals.

The product endorsement message(s) 142 generated at the step 306 can take a variety of forms depending upon the embodiment or operational circumstance. In some embodiments or circumstances, when a product such as the product 140 is identified in the step 304, a single standard product endorsement message is generated at the step 306 that is then suitable for sending to multiple personal contacts of the user who endorsed the product. In other embodiments, even when only a single product has been identified in the step 304, multiple different product endorsement messages are generated in relation to that product. In some cases, the different product endorsement messages are respectively tailored for the respective personal contacts of the user to whom those messages are intended to be sent. Further, the content or format of personal endorsement messages can vary considerably depending upon the embodiment or circumstance. In some embodiments or circumstances, for example, the personal endorsement messages are email messages or text messages. Also, in some embodiments or circumstances, the personal endorsement messages involve audio information, image information such as video imaging, or other forms of content, or combinations of one or more of the aforementioned types of content so as to be multimedia product endorsement messages.

Next, at a step 310, the process additionally involves informing a seller of the identified product that the product endorsement message(s) have been published, by informing the seller's application server. For example, with respect to FIG. 1, the product 140 identified at the first mobile device 104 that is the subject of the product endorsement message 142 is shown to be of the type offered by the seller 148 associated with the first seller application server 122. In such case, upon the publishing of the product endorsement message 142, the aggregation server 108 sends another message via the communication link 126 to the first seller application server 122 informing that application server and thus informing the seller 148 associated therewith that the endorsement of the seller's product has been published.

Although not required in every embodiment or situation, in the present embodiment of FIG. 3 subsequent to the step 310 a further step 312 is performed in which the seller (e.g., the seller 148 associated with the first seller application server 122) can determine whether it approves of the product endorsement message that was generated and published. Whether the seller 148 approves of the product endorsement message 142 can be determined either automatically by the seller application server 122 (e.g., based upon parameters previously defined for that application server by the seller or otherwise) or based upon one or more confirmation messages provided to the seller application server from the seller. The manner of providing such approval from the seller/seller application server can depend in part upon the manner in which the product endorsement message(s) 142 are sent. In one example, where the product endorsement message 142 is transmitted via email, the seller can be blind-copied on the email distribution list. In another example, where the product endorsement message 142 is transmitted by publishing the product endorsement message on a website page of a social networking website that belongs to (or is associated with) the user 138, the seller can obtain viewing permission from the user to view the web page thus allowing the seller to evaluate the endorsement message.

Assuming that the seller 148 does approve the product endorsement message 142, then at a step 314 the seller can further compensate the user 138 for making the product endorsement. Such compensation can take a variety of forms depending upon the embodiment. For example, in one embodiment, the seller application server 122 can send a message back to the mobile device 104 associated with the user 138, where the message indicates that the user now has an opportunity to receive a discount on some other product offered by the seller. Upon the completion of the step 314, the process then ends at the step 316.

It should be understood that the process represented by the flowchart 300 is only an example of steps that can be performed depending upon the embodiment of the present invention. Not all the steps shown in FIG. 3 need always be performed and, indeed, certain of the steps such as the steps 312 and 314 can be viewed as optional. At the same time, other steps can be added to the process represented by the flowchart 300 in other embodiments. Also, the steps of FIG. 3 can be rearranged relative to one another and other steps depending upon the embodiment. For example, as will be discussed further in relation to FIG. 4, in some embodiments seller approval is required to obtained prior to the sending of the product endorsement messages to the personal contacts of the user.

Turning to FIG. 4, an additional flowchart 400 shows exemplary steps of a further embodiment of a marketing method in accordance with another embodiment of the present invention. As shown, this embodiment includes a greater number of steps than the flowchart 300. Upon starting the process at a step 402, at a step 404 a mobile device client identifies a product. For example, the first mobile device 104, which is a client of the aggregation server 108, can identify a product of interest such as the product 140. The product of interest can be identified to the mobile device 104 (or be identified by the mobile device) in any of a variety of ways depending upon the embodiment. For example, the user 138 of the first mobile device 104 can provide an input signal or signals by way of one or more of the input devices 210 specifying a particular product that is of interest. Further for example, a product name can be typed into the mobile device 104, or an indication can be given by the user 138 to select a particular product name from a drop-down menu or other list of selectable product types displayed on one of the visual output devices 216 of the mobile device. The product can be identified also by way of a product identification code (ID) or any other unique ID. In an alternative method a product associated with a user can be identified by the mobile device 104 or a server such as the aggregation server 108, by identifying products having been purchased, through examination purchasing data, for example purchase records associated with on-line purchases, auctions, credit account, a debit accounts and the like.

Also, for example, the product 140 can be identified by way of one or more of the sensors 228 of the mobile device 104. In this regard, further for example, the user 138 can hold up the product 140 (or a picture of the product) in front of a camera or other imaging sensing device of the mobile device 104, and an image of the product can then be sensed and recognized by the mobile device 104 by way of associated image processing performed by the mobile device 104 (this can be termed “augmented reality”). In some embodiments, the mobile device 104 is able to determine the identity of the product 140 based upon a picture of the product provided on a product receipt. Also, in some embodiments, the mobile device 104 is capable of reading by way of a barcode scanner 231 or camera 222 a barcode associated with the product 140 and, by virtue of reading that barcode, capable of identifying the product. The barcode could be found, for example, on a product label, on a sales receipt, at a point of sale, on the product itself, etc.

Next, at a step 406 the mobile device 104 communicates with the aggregation server 108 to see if there is a marketing campaign for the product 140 that has been identified at the step 404. For example, the user 138 of the mobile device 104 can be solicited when at a point of sale by the aggregation server 108, in response to which the aggregation server finds out if a marketing campaign is going on regarding the identified product and provides that information back to the mobile device. Typically, the aggregation server 108 will not have the marketing campaign information in its possession already. Consequently, upon receiving the product identification information from the mobile client at the step 406, the aggregation server 108 communicates with the appropriate seller application server, which in this case is the first seller application server 122 of FIG. 1, to see if there is a marketing campaign for the product 140 that was identified. Upon determining whether there is a marketing campaign for the product 140 at the step 408, that information is provided back to the mobile device 104. Then, at a step 410, that mobile device 104 notifies the user 138 that there is a marketing campaign for the product 140 that the user has identified and that user endorsements are being accepted.

Next, at a step 412, the mobile device 104 also notifies the user 138 about the type of product endorsement messages that are accepted including, for example, text messages, audio messages, video messages, etc., as well as any deadline applicable for that type of endorsement. This information in some circumstances can also have been provided to the mobile device 104 from the aggregation server 108 (and, before that, from the seller application server 122). In some additional embodiments, the mobile device 104 provides additional information to the user 138 from the aggregation server 108 regarding other issues as well including. For example, in some embodiments, information is provided regarding how long of a time period that the marketing campaign for the product 140 will be going on. This timeline information in some such embodiments will then be enforced with respect to how or when product endorsement messages can be sent out. For example, in a circumstance where the product 140 is identified by the user 138 at the time of purchase, the timeline can be a few weeks from the date of purchase, to allow the user sufficient time to fully understand the product and its functionality in a manner that allows the user's endorsement to be more accurate.

Upon the user 138 being notified that a marketing campaign is being run in relation to the product 140 identified at the step 404 and that user endorsements of one or more types are being accepted, the user may wish to participate in the marketing campaign by providing his or her own endorsements of the product and having those endorsements communicated to the user's personal contacts. There are multiple reasons why the user 138 might wish to do this. For example, the user 138 may simply wish to endorse the product 140 because the user does, in fact, like or prefer the product. Alternatively, or in addition to that reason, as already discussed with respect to the step 314 of FIG. 3, the user 138 may also wish to participate in this manner insofar as the user may get additional benefits from the seller 148 of the product 140 assuming that the user actually provides the endorsements.

Although it is possible for the aggregation server 108 in some embodiments to generate product endorsement messages automatically on behalf of a user such as the user 138 who has indicated an interest in providing such an endorsement, in the embodiment of FIG. 4 the user 138 interacts with the mobile device 104 to develop the particular product endorsement message to be sent to the personal contacts of the user. More particularly, at a step 414 the mobile device 104 operates to provide helpful tips to the user 138 to facilitate a user's creation of the product endorsement message 142 that can be sent to third parties. In some cases, these tips merely are suggestions while in other circumstances the mobile device 104 displays a standard template or multiple standard templates that can be utilized by the user 138 to develop standardized or semi-standardized product endorsement messages (or, in some cases, both tips and templates are provided). Based upon these tips, at a step 416, the user 138 (assuming the user does wish to participate in the marketing campaign) creates the product endorsement message.

In some embodiments, the mobile device 104 further facilitates the creation of the product endorsement message 142 by allowing the user 138 to develop specific types of endorsement media. For example, in some embodiments, the mobile device 104 allows the user 138 to generate a personalized endorsement that includes video or audio recordings of the user himself or herself commenting on the product. Such recordings can be accomplished using the input devices 210/sensors 228 of the mobile device 104 itself (e.g., a camera) or using information imported from other devices (e.g., a camcorder or voice recorder). It should be noted that, although in this embodiment the message generation process involves interactions between the user 138 and the mobile device 104, the amount of user input can vary considerably depending upon the particular circumstance and, in some circumstances, the message generation process can be largely if not entirely automatically performed, by way of the mobile device 104 and/or the aggregation server 108.

Upon the product endorsement message 142 being created at the step 416, at a step 417 the mobile device 104 then sends (or uploads) the endorsement to the aggregation server 108. In response, at a step 418, the aggregation server 108 verifies the content of the endorsement and/or otherwise determines whether to approve the product endorsement message 142. In some cases, this verification/approval merely involves the aggregation server 108 taking steps to verify that the endorsement satisfies certain standard obligations in terms of accuracy and/or does not include any errors in terms of product identification or the like. In other embodiments, the aggregation server 108 determines whether the product endorsement message 142 satisfies particular requirements established by the seller 148 of the product 140 including, for example, requirements determined by that seller as being pertinent to the marketing campaign that is underway. Although not shown, such requirements established by the seller 148 can be communicated from the first seller application server 122 to the aggregation server 108 (either at this time or an earlier time).

Also, in some alternate embodiments, at the step 418 the aggregation server 108 can also determine whether the product endorsement message 142 is appropriate for all of the personal contacts of the user 138 of the mobile device 104 or only some of those personal contacts. That is, in some such embodiments, multiple different versions of the product endorsement message 142 (or multiple different messages) are intended to be sent out to different ones of the personal contacts, and are specially-tailored for those different personal contacts. It should be noted that, in making such a determination, it can be advantageous for the aggregation server 108 to review the contact information 146 regarding the personal contacts of the user 138 to the extent such contact information is already available to the aggregation server. The contact information 146 in some circumstances can include not only information regarding how to contact particular parties, but also information regarding personal preferences or other attributes of those parties that can influence a determination of whether or in what manner product endorsement messages should be sent to those parties. While in the present embodiment of FIG. 4 the aggregation server 108 does not obtain the contact information 146 until a step 422 as discussed below, in such alternate embodiments the contact information can be obtained at an earlier time or even updated on a periodic or regular basis.

Further, while in some embodiments the aggregation server 108 determines whether to approve a proposed endorsement message, in other embodiments the proposed endorsement message is provided further to one or more (as appropriate) of the seller application servers (e.g., the seller application server 122) for approval by the seller(s). Also, while in the above-described examples approval of a proposed endorsement message occurs prior to the publishing of the message, as already discussed with reference to FIG. 3 in other embodiments the endorsement messages are reviewed (e.g., by the aggregation server 108 or by one of the sellers/seller application servers) after the messages have been published.

Following the verification (or other review or approval consideration) performed at the step 418, if at a step 419 the aggregation server 108 does not approve the product endorsement message, then the aggregation server at a further step 420 sends a denial message to the first mobile device 104 indicating that the proposed produce endorsement message is unsatisfactory (and often also the reason(s) why this is the case). Upon the sending of the denial message, in the present embodiment, the process then returns to the step 416 in which the user again creates (that is, re-creates) a product endorsement message. Alternatively, if at the step 419 the aggregation server 108 approves of the product endorsement message, then the process further advances to a step 421, at which the aggregation server 108 considers whether the product endorsement message will be sent to (published with respect to) the receiving devices such as the second mobile device 106 by the aggregation server itself or instead will be sent by the first mobile device 104 associated with the user 138 who has endorsed the product 140.

Although the flow chart 400 of FIG. 4 shows both publishing avenues (that is, publishing by the aggregation server 108 as well as publishing by the mobile device 104) to be available as determined by the aggregation server, in alternate embodiments only one of the aggregation server and the mobile device does the publishing. Also, in some cases, the determination of which device does the publishing is made by the mobile device 104, or collaboratively between the mobile device and the aggregation server 108. Further, in some additional embodiments, a device or group of devices other than or in addition to the aggregation server 108 or the mobile device 104 associated with the user 138 making the endorsement can be the device(s) that send out the endorsement messages to the personal contacts of the user.

If at the step 421 it is determined that the aggregation server 108 is to do the publishing, then prior to doing such publishing the aggregation server needs to have assembled or aggregated the contact information 146 for those personal contacts. At a step 422, therefore, the aggregation server 108 obtains and aggregates the users' contact information. It will be understood that the aggregation server 108 can aggregate the contact information 146 in a variety of matters depending upon the embodiment of the invention. In some cases, for example, the aggregation server 108 will merely inquire with the mobile device 104 as to contact information stored at the mobile device 104 and the mobile device in turn will provide that contact information to the aggregation server. In other embodiments, the aggregation server 108 is able to collect some or all of the contact information 146 pertinent to the user 138 of the mobile device 104 from a variety of sources other than, or in addition to, the mobile device 104. For example, in some circumstances, the aggregation server 108 has rights (or maintains rights) to access third party social networking websites (not shown) to obtain information about the user's personal contacts from those websites to the extent that the user has established accounts on those websites. As noted above, the time at which such contact information is aggregated need not necessarily occur subsequent to the performing of the step 421 in all embodiments and, indeed, in some embodiments such aggregation can be an ongoing process performed by the aggregation server 108.

Assuming that the aggregation server 108 is responsible for publishing the message as determined at the step 421, and further assuming that the product endorsement message 142 has been approved and that the aggregation server has the contact information 146 to be used in publishing the message, then at a step 423 the aggregation server 108 publishes (or posts) the product endorsement message to the receiving devices associated with the user's personal contacts including, for example, the mobile device 106 associated with the personal contact 144. The aggregation server 108 can cause the publication of the product endorsement message by sending out the message by way of appropriate ones of the communication links such as the communication links 118 and 116 of FIG. 1, so that the product endorsement message is communicated to appropriate receiving devices associated respectively with those respective personal contacts. As noted above, in some circumstances where only certain personal contacts are appropriate for receiving the product endorsement message 142, the product endorsement message is sent only to those selected users.

Alternatively, if it is the first mobile device 104 that is responsible for publishing the message as determined at the step 421 (and assuming that the product endorsement message 142 has been approved at the step 419), then at a step 424 the first mobile device 104 associated with the user 138 endorsing the product 140 publishes (or posts) the product endorsement message itself, without assistance from the aggregation server 108. In some circumstances, this publishing only occurs in response to an express command provided by the user 138 to the mobile device 104 (e.g., by way of one or more of the input devices 210). The sending of the product endorsement message proceeds by appropriate ones of the communication links. For example, to send the product endorsement message 142 to the second mobile device 106, the message would be sent by way of the communication links 114, 116 and the wireless infrastructure 110 shown in FIG. 1.

Depending upon the embodiment, the manner of publishing performed by way of either the aggregation server 108 or the mobile device 104 associated with the user 138 endorsing the product 140 can take a variety of forms. In some embodiments, one or more of the product endorsement messages are respectively directly sent from the sending entity (the aggregation server or mobile device) to each respective receiving device (e.g., the mobile device 106), for example, as independent and distinct email messages (or email pages on login, or other message signatures). In other embodiments, the user 138 (or mobile device or aggregation server acting on behalf thereof) can instead post the product endorsement message onto the user's social network website(s) and/or cause messages to be sent to the user's contacts by way of the communication mechanisms afforded by way of those social networking websites. More particularly, for example, the product endorsement messages can be published via social networking website personal pages (e.g., as found on Facebook, Myspace™, etc.), mobile-based social networks (e.g., Latitude, etc.), personal pages or blogs, alumni pages, accounts with a user name and password, searchable databases available to users' personal networks, etc.

In alternate embodiments, the publishing of the product endorsement message 142 can be performed by one or more of the seller application servers such as the first seller application server 122 on behalf of one or more sellers such as the seller 148. To accomplish this, the proposed product endorsement message generated by the user 138/mobile device 104 is provided from the user/mobile device to the aggregation server 108 and subsequently to the seller application server 122. Further in the alternative, the seller application server 122 can itself generate the appropriate product endorsement message simply upon receiving a message from the mobile device 104 (via the aggregation server 108) that the user 138 has agreed to endorse the product 140 provided by the seller 148. In one example, the seller application server 122 can accomplish such a publishing of the product endorsement message simply by sending a banner advertisement to be placed on a website page of a social networking website of the user 138.

Once the product endorsement message(s) 142 have been published or posted, either at the step 423 or at the step 424, then the process further advances to a step 426 at which the user 138 is compensated for the user's endorsement of the product 140 and the user's publishing of that endorsement. As shown in FIG. 4, the user 138 can be compensated in a variety of manners, for example, by way of discounts or points or immediate monetary payments (including credit card or debit card payments or advances). Such discounts, points, and/or monetary payments can be communicated from the aggregation server 108 to the mobile device 104 of the user 138 based upon communications the aggregation server 108 has with the seller application server (e.g., the first seller application server 122) associated with the product 140 that was promoted. In addition (or alternatively), as shown at a step 428, the user 138 can be further compensated when the endorsement leads to the purchase of the product 140 that was endorsed by another party, particularly one of the personal contacts who received the endorsement.

Such compensation can occur in a variety of manners and involve additional steps not shown in FIG. 4. For example, if the personal contact 144 associated with the second mobile device 106 upon receiving the product endorsement message 142 later purchases a product of the same type as the product 140 endorsed by the user 138, and further that personal contact provides a response message (e.g., by clicking a link provided by the product endorsement itself) indicating that the personal contact has purchased the product, then the aggregation server 108 will be notified that the product has been purchased in response to the sending of the product endorsement message. Then, based upon that information, the aggregation server 108 can further provide to the mobile device 104 (after communicating appropriately with the first seller application server 122) a discount, point or dollar payment compensation for the user 138 of the first mobile device 104 due to the purchase of the product 140 by the personal contact 144.

The user 138 who authorized and caused the sending of the product endorsement message 142 in some cases is not the only person who can benefit in terms of being compensated by the seller 148 of the product 140 being promoted. In some further cases, as shown by a step 430, those of the personal contacts of the user 138 who receive the product endorsement message 142 (e.g., the personal contact 144) and who then ultimately purchase the product being promoted by the endorsement also can be compensated in some manner by the seller 148 of that product. This can be desirable because it can reinforce the relationship or connection between the original user 138 who has sent out the product endorsement message 144 and the user's personal contacts. Also, as shown in a step 432, the mobile device 104 of the user 138 who has caused the publishing of the product endorsement message(s) 142 can notify and keep track of the user's points, discounts and other compensation, as well as possibly any compensation provided to the user's personal contacts as can occur in accordance with the step 430. For example, where points/discounts have been provided by a particular one of the sellers such as the seller 148 to the user 138 following the user's endorsement, the mobile device 104 can determine and/or remind the user 138 of the availability of those points/discounts when the user is making other product purchases. Subsequently, the process ends at a step 434, although it will be understood that the process can continue operating or repeat indefinitely.

It will be appreciated from the above discussion that one or more embodiments of the present invention can be advantageous as marketing methods, particularly insofar as the product endorsement messages that are sent out will more closely align with consumer desires on a number of counts. In particular, by virtue of having product endorsement messages sent from users to the user's own personal contacts, the recipients of the endorsement messages are more likely to consider the endorsement messages and positively respond to (be influenced by) those message in terms of considering purchasing or using the endorsed products. In this respect the sending of product endorsement messages in the above-described manners to personal contacts is able to obtain benefits similar to word-of-mouth marketing.

Additionally, since the user endorsing the product can often have similar preferences to those of the user's personal contacts, the endorsement messages can for that reason be more closely aligned with the recipients' preferences. Further, to the extent that the user publishing the endorsement messages takes into account the personal preferences of the user's personal contacts and personally tailors the endorsement messages for those different personal contacts, the promotional value will likely be even more appropriately suited for those contacts. A seller can also in some embodiments monitor the product endorsement messages that are sent out and, based upon the collected information, further adjust the seller's marketing campaign, adjust the tips (e.g., suggested features or templates) provided to the user for the purpose of generating the product endorsement messages, and adjust the requirements that the seller specifies for such product endorsement messages. All of these adjustments can potentially further enhance the marketing of the seller's product.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of marketing a product, the method comprising:
identifying the product at a mobile device associated with a user;
generating a message indicative of an endorsement of the product by the user, the generating being performed at least in part by way of the mobile device; and
causing, by way of the mobile device, a sending of the message to at least one receiving device associated with at least one personal social contact of the user, and
wherein due to the causing, a seller of the product is also notified that the sending of the message has occurred.

2. The method of claim 1, wherein the mobile device causes the sending of the message by communicating with an aggregation server that is independent of the mobile device, and wherein the aggregation server in response sends the message.

3. The method of claim 2, wherein the at least one receiving device includes a plurality of receiving devices, wherein the at least one personal social contact of the user includes a plurality of personal social contacts of the user that are respectively associated with the respective receiving devices, wherein the aggregation server publishes the message by sending the message for receipt by the plurality of receiving devices, and wherein a first of the plurality of receiving devices is an additional mobile device.

4. The method of claim 1, further comprising:
receiving a signal at the mobile device from a server that is indicative of an amount of compensation being accorded to the user from a seller of the product in view of the causing of the sending of the message, the compensation being in the form of one or more of money, points or discounts.

5. The method of claim 1, wherein the mobile device causes the sending of the message by transmitting a plurality of signals onto an internet-type communications medium for receipt respectively by the at least one receiving device.

6. The method of claim 1, wherein the mobile device causes the sending of the message by posting the message onto one or more pages of a social networking website associated with the user.

7. The method of claim 1, wherein the product is identified due to at least one of (a) receiving at the mobile device of a first input signal from the user by which the user has specified the product, (b) receiving at the mobile device of a second input signal from the user by which the user has indicated a selection of the product from among a plurality of products displayed on a screen of the mobile device, (c) receiving at a scanner of the mobile device of light reflected off of a bar code associated with the product, and (d) receiving, either at the scanner or at another light sensor of the mobile device, light containing imaging information representative of an image of the product.

8. The method of claim 1, further comprising:
outputting from the mobile device information regarding a type of message that is acceptable; and
displaying on a screen of the mobile device at least one of a suggestion and a template intended to facilitate the generating of the message.

9. The method of claim 1, further comprising:
providing an output message from the mobile device indicative of whether a marketing campaign currently is active that pertains to the product.

10. A method of marketing a product, the method comprising:
receiving at a first server, from a mobile device associated with a user, an indication of a product that has been identified;
communicating with the mobile device regarding a message indicative of an endorsement of the product by the user;
verifying that the message satisfies at least one criterion established by a seller of the product; and
causing the message to be sent to at least one receiving device associated with at least one personal contact of the user.

11. The method of claim 10, further comprising:
receiving an indication from a second server associated with the seller of the product as to whether a marketing campaign pertaining to the product is currently active; and
upon receiving the indication that the marketing campaign is currently active, providing a further indication to the mobile device that the marketing campaign is currently active, whereby the mobile device in turn is able to provide notification to the user that the marketing campaign is currently active in relation to the product in accordance with which the message can be sent.

12. The method of claim 11, wherein the communicating with the mobile device includes receiving the message at the first server from the mobile device, the message being created at the mobile device based upon one or more instructions from the user.

13. The method of claim 10, further comprising:
aggregating at the first server contact information regarding the at least one personal contact,
wherein the message is sent from the first server to the at least one receiving device.

14. The method of claim 10, further comprising:
subsequent to the causing, sending a signal from the first server to a second server associated with the seller of the product indicating that the message has been sent.

15. The method of claim 10, further comprising:
providing a signal from the first server to the mobile device indicating that an amount of compensation is to be provided to the user in view of the sending of the message, wherein the compensation can include one or more of a discount, a point allocation, or a monetary payment.

16. The method of claim 10, wherein the at least one receiving device includes at least one additional mobile device, and wherein the first server is in communication with each of the mobile devices by way of one or more wireless communication links.

17. A system for marketing, the system comprising:
a mobile device having a plurality of components including a processing device, a memory device, one or more input devices, and a wireless transceiver, wherein each of the memory device, the one or more input devices, and the wireless transceiver are connected at least indirectly with the processing device by way of one or more internal communication links,
wherein the one or more input devices includes one or more of a user interface by which a user can identify a product, a scanner by which a bar code associated with the product can be detected by the mobile device, and an image detector by which an image of the product can be detected,
wherein the mobile device is capable of being operated by a user so as to generate a message endorsing the product, and
wherein the mobile device is capable of communicating via the wireless transceiver with a first server with respect to the message and, as a result of the communicating, the message is transmitted to one or more receiving devices associated with one or more personal contacts of the user.

18. The system of claim 17, further comprising the first server, wherein the first server conducts communications with each of the mobile device, the one or more receiving devices and a second server associated with a seller of the product.

19. The system of claim 18, wherein the first server includes a memory device on which is stored contact information regarding the one or more personal contacts of the user, and wherein the first server causes transmission of the message to the one or more receiving devices using the contact information.

20. The system of claim 18, wherein the first server verifies whether the message satisfies at least one criterion specified by the second server prior to the transmission of the message to the one or more receiving devices, and wherein the first server communicates to the mobile device an indication of an amount of compensation provided to the user from the seller in view of the transmission of the message.
